(19) United States
(12) Patent Application Publication
(10) Pub. No.: US 2024/0337149 A1
(43) Pub. Date: Oct. 10, 2024

(54) Pocket Window

(71) Applicant: Allison McGregor, East Lansing, MI (US)

(72) Inventor: Allison McGregor, East Lansing, MI (US)

(21) Appl. No.: 18/132,700

(22) Filed: Apr. 10, 2023

(51) Int. Cl. E06B 3/46; E06B 3/44

(52) U.S. Cl. CPC E06B 3/4654; E06B 3/4423

(57) ABSTRACT

A pocket window system comprising a pocket inside of a wall that a window can slide into and out of, so that the window is not visible when it is open. The pocket for the window is located between two wall structures, and the window fits between the two wall structures. The window slides on a track that extends into the pocket between the walls. The window has a handle for grasping and a sliding material affixed to at least one side of the window that is in contact with the track.

### FIELD OF THE INVENTION

This invention relates generally to an improved window system.

### BACKGROUND OF THE INVENTION

The present invention is a new design for windows in residential buildings and houses to allow maximum air flow and ventilation when room space is limited and to increase the functionality and aesthetic of rooms.

### SUMMARY OF THE INVENTION

The present disclosure provides a pocket window that includes a window pane that moves along a track between a closed position, with the window pane spanning a window opening in a wall, and an open position, with the window pane withdrawn into a window cavity within the wall adjacent to the window opening. By providing a window that disappears when the window is open, the pocket window allows for the window pane to be withdrawn into the wall when the window is open.

In one embodiment, the pocket window includes a window frame that moves along a track mounted along a window opening in a wall and into a windowpane cavity within the wall adjacent to the window opening. The pocket window moves between a closed position, with the window frame spanning the window opening, and an opened position, with the window frame withdrawn into the windowpane cavity.

The pocket window of the present disclosure can be placed anywhere on a wall in which the edge of the window frame is at a lateral or vertical distance at least the size of one windowpane on either side. This would allow the window to be fully enclosed in the wall when the pocket window is in the opened positioned, so it would not be visible. During use, the pocket window is opened by sliding the windowpane into the windowpane cavity in the wall. The windowpane cavity can be positioned along a lateral direction or a vertical direction relative to the window opening in the wall. The pocket window is closed by sliding the window back into the frame using a lip or handle that is attached to the window. The lip or handle is made to be grasped to push or pull the window back into place either vertically or horizontally. In the vertical embodiment, the pocket window also has an additional latching mechanism to account for gravity. The latching mechanism may be configured to hold the windowpane at intermediate positions between the opened and closed positions as well. On both sides of the windowpane there is a latching or locking mechanism that fits into grooves along the track for the window to remain open at various ventilatory positions without falling.

One advantage provided by the pocket window is maximizing the use of wall space, especially with smaller walls. The pocket window system occupies the same space as a conventional slider window except the pocket window provides additional wall space. One advantage of the pocket window is being able to open the window 100% of the way to increase ventilatory capacity rather than only 50%. Similarly, with the ability of a regular window only being able to open 50% of the way, the pocket window could be half of the size while providing the same amount of ventilation.

The pocket window may also increase the functionality of certain rooms. For example, the pocket window could be useful in “four-season rooms” or in “sunrooms” in place of regular windows. This would allow these spaces to be converted to a screened-in porch in the summertime with all the pocket windows open and a sunroom in the winter providing dual functionality of the room. Furthermore, the pocket window could be used in place of “pass through” windows, commonly found in kitchens, which connect indoor and outdoor dining areas to enhance the aesthetic. Current “pass through” windows either fold to the sides or lift without being able to be completely concealed.

According to one embodiment of the invention, a pocket window system includes a pocket assembly for concealing windows when the windows are open, comprising an opening within a wall, a window that fits inside the opening, a track affixed to the opening for which the window can slide, a handle affixed to the window, and a sliding material affixed to the window.

### BRIEF DESCRIPTION OF THE DRAWING

The embodiments of the invention are illustrated in the accompanying drawings in which:

FIG. 1 is a perspective view of a pocket window system of the present application.

FIG. 2 is a front view of the pocket window system shown in FIG. 1 which shows the pocket window system in an opened position.

FIG. 3A is a cross-sectional side view of the pocket window system generally taken along lines 3-3 of FIG. 2.

FIGS. 3B and 3C are detailed views of the top and bottom track systems of the pocket window system shown in FIG. 3A.

FIG. 4 is a side view of the pocket window system of FIG. 3A.

FIG. 5 is a front view of FIG. 1 in which the pocket window system is in a closed position.

FIG. 5A is a front view of the lock shown in FIG. 5.

### DETAILED DESCRIPTION OF THE ILLUSTRATED EMBODIMENT

The invention is described in more detail with reference to exemplary embodiments of the invention as shown in the appended drawings. The invention is not limited to the illustrated embodiments hereto. Those of ordinary skill in the art who have access to the drawings and description herein will identify additional implementations, modifications, and embodiments which are within the scope of the invention as disclosed and claimed. For the purposes of clarity, not every component is labeled in every figure, nor is every component of each embodiment of the invention shown where illustration is not necessary to allow those of ordinary skill in the art to understand the invention.

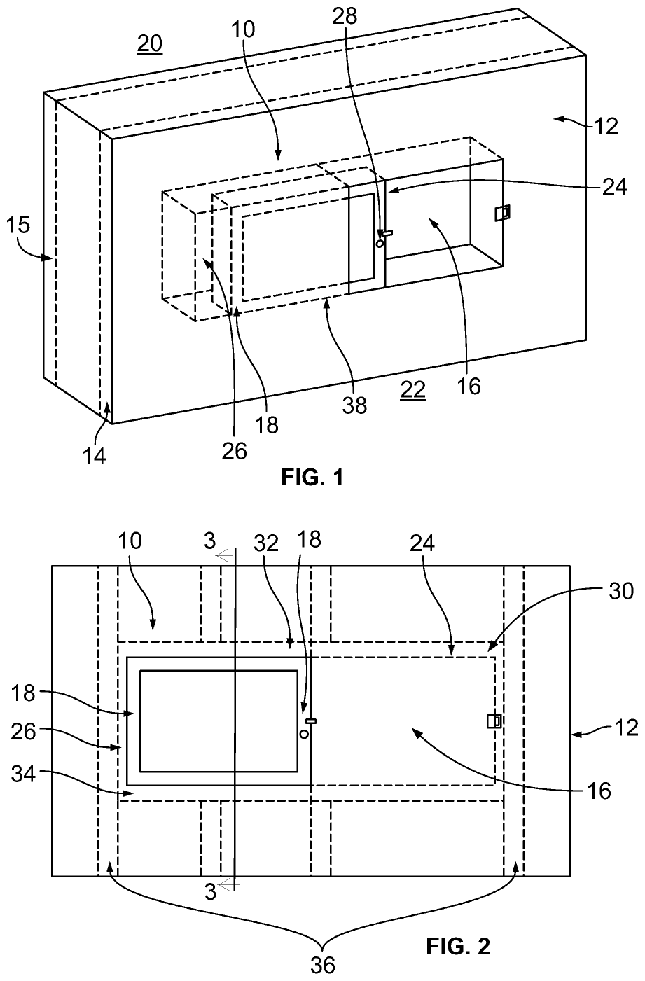

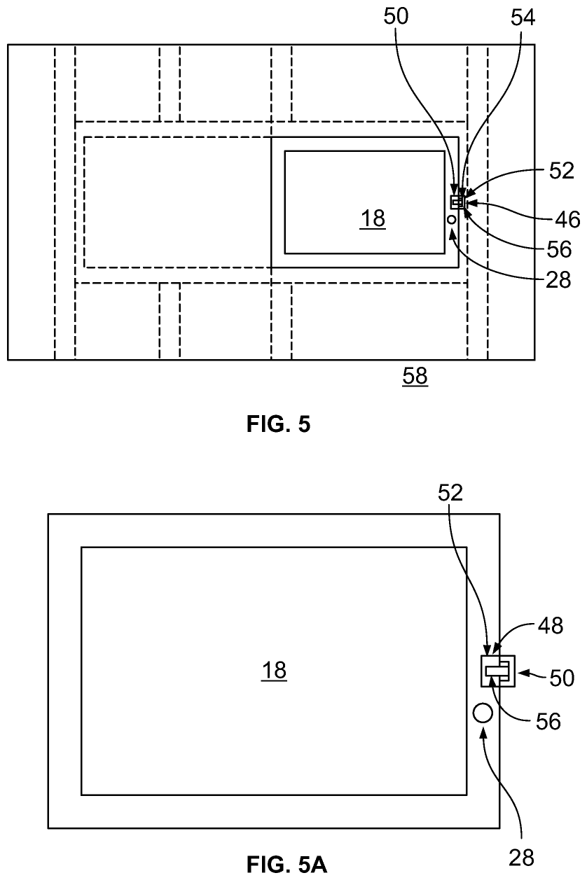

Referring to the drawings, and initially to FIG. 1, a pocket window system 10 is shown installed within the finished foundation of the wall 12. Some component parts of the pocket window system 10 which are discussed in detail below, are not shown in FIG. 1 for clarity purposes. The finished foundation of the wall 12 comprises inner and outer wall surface structures 14 and 15, such as drywall, plasterboard, or the like, and includes an opening or window 16 for the pocket windowpane 18 to slide into and out of through wall surface structures 14 and 15 between an opened position (see FIG. 2) and a closed position (see FIG. 5). The pocket windowpane 18 comprises a pane of glass, acrylic, or other transparent/opaque material within a wood, metal, or other material casings. As shown in FIG. 1, the pocket window system 10 allows airflow from one room or outside source 20 to a second room 22 when the pocket windowpane 18 is in the closed position.

The wall 12 includes the window opening 16 defined by window opening side surfaces within the wall surface structures 14 and 15 and a windowpane cavity 26 defined by cavity surfaces internal to the wall adjacent the window opening. The window opening 16 and the windowpane cavity 26 together form an outer window 24. The pocket windowpane 18 may be provided within a rail or other frame received onto a track 40 mounted to the window opening side surfaces of the window opening 16 and the cavity surfaces of the windowpane cavity 26, between walls 14 and 15.

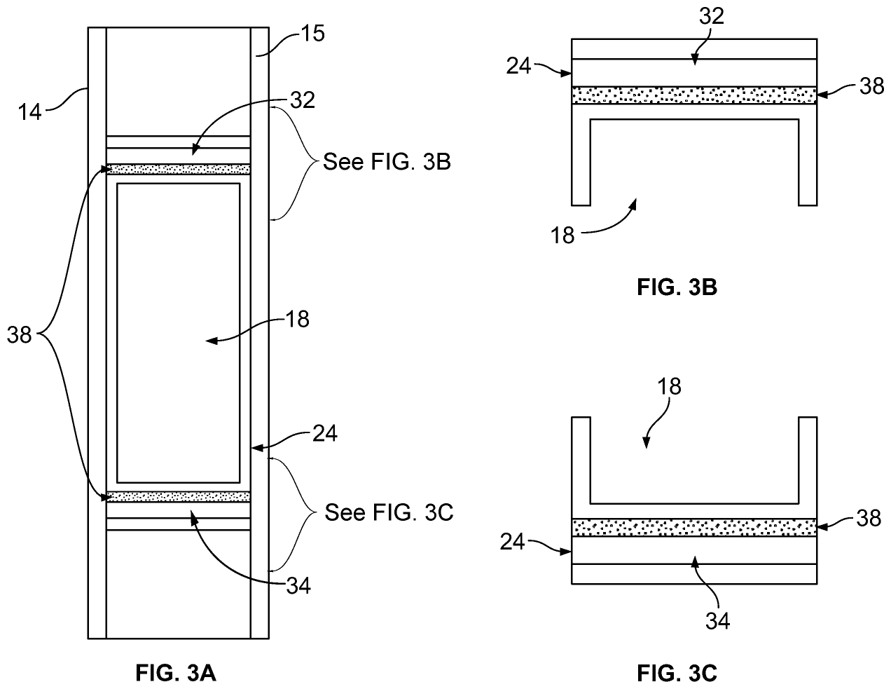

When the pocket windowpane 18 is slid from the opening 16 into the windowpane cavity 26 (FIG. 1), the pocket window system 10 is in the opened position. The pocket windowpane 18 is affixed with a handle, knob, lip, or other grasping device or structure 28 so that the pocket windowpane 18 can be easily grasped and slid into the opening 16 when it is in the windowpane cavity 26, and vice versa. For the ease of sliding the pocket windowpane 18, a sliding material 38 may be attached to the sides of the pocket windowpane 18 in the embodiment shown in FIGS. 3A-C. In an embodiment where the pocket windowpane 18 moves vertically, sliding material 38 is attached to the sides of the pocket windowpane 18 (not shown in the figures).

Referring to FIGS. 2 and 3A-C, the pocket window system 10 is shown in a frame 30 positioned in the outer window 24 between the inner and outer walls 14 and 15 of the wall 12. The frame 30 includes a first side header 32 and a second side header 34, which are the same horizontal length as the horizontal length of the window opening 16, supported at its ends by a pair of vertical studs 36. The pocket window system 10 can be affixed either horizontally or vertically into the foundation of the wall 12. The pocket window system 10 is sized so that the full window opening 16 is provided when the pocket windowpane 18 is slid into the windowpane cavity 26 as shown in FIG. 2.

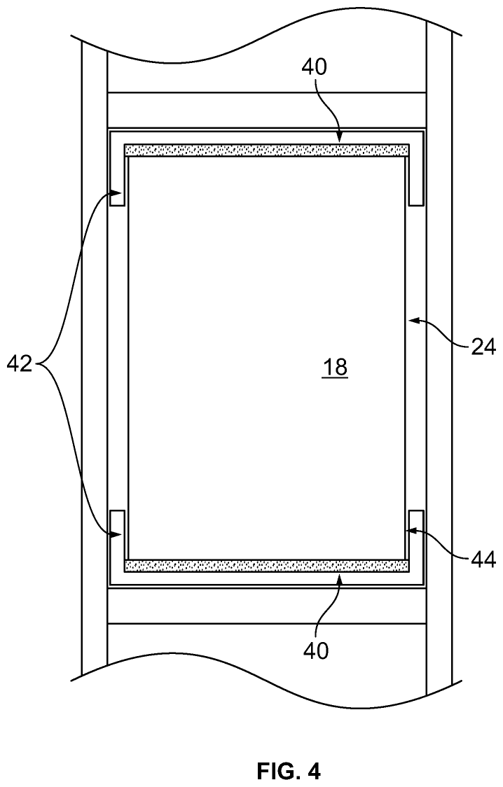

As shown in the embodiment of FIGS. 3A-3C and 4, the upper header 32 and the lower header 34 of the frame 30 are mounted directly on the top and bottom sides of the outer window 24 between walls 14 and 15. The pocket windowpane 18 is compartmentalized within the window opening 24 and the sliding material 38 is attached to the edges of the pocket windowpane 18 contacting the surfaces of the window opening 24.

The track 40 in which the pocket windowpane 18 sits inside the window opening 24 is shown best in FIG. 4. The window opening 24 has a width that extends beyond a width of the pocket windowpane 18 so that the pocket windowpane 18 fits inside the window opening 24. The facial edges 42 of the window frame 30 extend over the facial edges 44 of the pocket window so that the pocket windowpane 18 does not fall out of the window opening 24. The design of the facial edges 42 of the inner surfaces of the window opening 24 creates the track 40 for the pocket windowpane 18.

The lock 46 and handle 28 are best shown in FIGS. 1, 5, and 5A. In one embodiment, the lock 46 comprises two parts. The latch part 48 is affixed to the pocket windowpane 18 and the stabilized latch attachment 50 is affixed to the window opening 24. The latch part 48 comprises a base 52 that mounts a switch 54 that controls the latch mechanism 56 that is housed inside the base 52. The latch mechanism 56 hooks onto the stabilized latch attachment 50 when the pocket windowpane 18 is to be locked shut. The handle 28 is affixed to the facial edge of the pocket window facing the inside of room 58 in which the user will grasp to slide the pocket windowpane 18. The handle 28 is affixed to the side of the pocket windowpane 18 which is closest to the side in which the pocket windowpane 18 is closed.

In some embodiments, additional components such as a screen or hidden latches may be provided.

In some embodiments, for the ease of installing the pocket window, the pocket windowpane and its frame should be installed before the inner drywall, or other wall material that would be used for the wall. In other embodiments, the pocket window system may be installed in an existing wall.

While reference has been made to various illustrated embodiments of the invention, other variations are comprehended by the broad scope of the appended claims. Some of these embodiments have been discussed in detail in this specification and others will be apparent to those skilled in the art. All such variations and alterations are comprehended by this specification and are intended to be covered, without limitation.

I claim:

1. A pocket window system configured to fit in a wall, wherein the wall includes a window opening defined by window opening side surfaces and a windowpane cavity defined by cavity surfaces internal to the wall adjacent the window opening, the pocket window system comprising:
a track secured to the window opening side surfaces of the window opening and the cavity surfaces of the windowpane cavity;
a windowpane mounted within a frame, the frame sized to fit inside the window opening and the windowpane cavity of the wall; and
a handle affixed to the windowpane.

2. The pocket window system as claimed in claim 1 wherein said windowpane is configured to move between a closed position and an opened position, wherein the windowpane spans the window opening in the closed position, and wherein the windowpane is withdrawn into the windowpane cavity in the opened position.

3. The pocket window system as claimed in claim 2 wherein the windowpane slides along the track between the opened position and the closed position.

4. The pocket window system as claimed in claim 1 wherein the handle is affixed to the windowpane at an edge of the windowpane, the edge being furthest away from the windowpane cavity.

5. The pocket window system as claimed in claim 4 wherein said handle comprises one of a knob, a latch, and a lip.

6. The pocket window system as claimed in claim 1 further comprising a sliding material affixed to at least one side of the track and the windowpane.

7. The pocket window system as claimed in claim 6 wherein the sliding material is affixed to at least one side of the frame of the windowpane that is in contact with the track.

8. The pocket window system as claimed in claim 7 wherein the windowpane slides horizontally and the sliding material is affixed to a bottom side of the windowpane.

9. The pocket window system as claimed in claim 7 wherein the windowpane slides vertically and the sliding material is affixed to both vertical side edges of the windowpane.

10. The pocket window system as claimed in claim 7 wherein the sliding material comprising at least one of felt, roller bearings, or a low-friction strip.

11. The pocket window system as claimed in claim 1 wherein said frame comprises at least one of hard plastic, metal, or wood.
